(19) United States
(12) Patent Application Publication
(10) Pub. No.: US 2021/0094136 A1
(43) Pub. Date: Apr. 1, 2021

(54) DETECTION SYSTEM FOR DETECTING WORKPIECE

(71) Applicant: Fanuc Corporation, Minamitsuru-gun (JP)

(72) Inventor: Masafumi Ooba, Minamitsuru-gun (JP)

(73) Assignee: Fanuc Corporation, Minamitsuru-gun (JP)

(21) Appl. No.: 16/941,745

(22) Filed: Jul. 29, 2020

(30) Foreign Application Priority Data
Sep. 27, 2019 (JP) 2019-177214

(51) Int. Cl. B23Q 17/20; B23Q 17/22

(52) U.S. Cl. CPC B23Q 17/20; B23Q 17/2409; B23Q 2717/00; B23Q 17/22

(57) ABSTRACT

The detection system includes a height measurement sensor which measures height of a moving workpiece, a two-dimensional sensor which acquires two-dimensional information of the workpiece, an execution management section which manages execution timing of at least one of the height measurement sensor and the two-dimensional sensor, and a workpiece detection section which detects at least a position of the workpiece based on the measured height and the acquired two-dimensional information.

### BACKGROUND OF THE INVENTION

### 1. Field of the Invention

The present invention relates to a detection system for detecting a workpiece, and in particular, relates to a detection system for detecting a workpiece by combining a height measurement sensor with a two-dimensional sensor.

### 2. Description of the Related Art

When an operation is performed on a moving workpiece using a machine such as an industrial robot, the workpiece may be detected using only an inexpensive two-dimensional sensor without using an expensive three-dimensional sensor. Furthermore, a workpiece may be detected by combining an inexpensive height measurement sensor with a two-dimensional sensor. As such a detection system, for example, the following literature is known.

Japanese Unexamined Patent Publication (Kokai) No. 2019-076972 discloses that when the height dimension of a conveying surface from a floor surface is unknown, the separation distance between the conveying surface and a camera position is detected with a laser scanner or the like separately provided in the camera, and the current position information of the workpiece including the height position of the workpiece in the machine coordinate system thereof is detected based on the separation distance.

Japanese Unexamined Patent Publication (Kokai) No. 2019-025618 discloses a workpiece measuring device that combines an image sensor and a distance measurement sensor, and an arrival predicting section that determines the predicted picking position and predicted arrival time of a workpiece based on conveying speed information supplied from a conveying device and sensing information supplied from an image acquisition device.

Japanese Laid-Open PCT Publication No. 2013/150598 discloses a camera which images a transported package upstream of a conveyance path from above and outputting it to an image processing device, an image processing device which analyzes the output image information and detecting the position, posture, and shape of the package (shape of the upper surface of the package) and the like, and a height sensor which detects a dimension in the height direction of the package based on the height position of a laser beam the optical path of which between a light emitting section and a light receiving section, which are arranged facing each other across the conveyance path, is occluded by the transported package.

### SUMMARY OF THE INVENTION

If the position of the workpiece is detected from the two-dimensional information without considering the height of the workpiece, the position of the detected workpiece will deviate from the actual position of the workpiece due to the influence of parallax, whereby the machine may move to the wrong target position and fail the operation on the workpiece. FIG. 6 shows an example of a conventional workpiece detection method. In FIG. 6, two workpieces 60 and 61 are depicted, the heights Ha and Hb of the workpieces 60 and 61 are different, and the center of gravity positions A and B of the upper surfaces of the workpieces 60 and 61 are at the same position on the XY plane. At this time, when detecting the position of the workpiece 60 at the height Hb of the workpiece 61, the center of gravity position of the upper surface of the workpiece 60 on the XY plane is detected as an incorrect position A′, thus resulting in deviation from the actual positions A, B of the workpieces 60, 61. Conversely, when detecting the center of gravity position of the upper surface of the workpiece by predicting the height from the detected size of the workpiece, the height Ha of the workpiece 60 may not be accurately predicted under the influence of lens aberration of the two-dimensional sensor 62.

Further, when detecting a workpiece by combining a height measurement sensor with a two-dimensional sensor, even if the workpiece can be detected with one sensor, the other sensor may miss the workpiece due to the workpiece speed or workpiece amount, whereby it may not be possible to measure the position of the workpiece.

Therefore, a technology which provides a highly reliable detection system without using an expensive three-dimensional sensor is desired.

An aspect of the present disclosure provides a detection system comprising a height measurement sensor which measures a height of a moving workpiece, a two-dimensional sensor which acquires two-dimensional information of the workpiece, an execution management section which manages execution timing of at least one of the height measurement sensor and the two-dimensional sensor, and a workpiece detection section which detects at least a position of the workpiece based on the measured height and the acquired two-dimensional information.

### BRIEF DESCRIPTION OF THE DRAWINGS

FIG. 1 is a perspective view showing the schematic configuration of a detection system according to an embodiment.

FIG. 2 is a perspective view showing a modified example of the configuration of the detection system.

FIG. 3 is a functional block diagram of the detection system according to the embodiment.

FIG. 4 is a functional block diagram of a detection system according to another embodiment.

FIG. 5 is a flowchart showing the schematic operations of the detection system.

FIG. 6 is a perspective view showing an example of a conventional workpiece detection method.

### DETAILED DESCRIPTION

The embodiments of the present disclosure will be described in detail below with reference to the accompanying drawings. In the drawings, identical or similar constituent elements are assigned the same or similar reference signs. Furthermore, the embodiments described below do not limit the technical scope of the invention or the definitions of the terms described in the claims. Note that the term “workpiece height” in this document refers to the distance from the support surface of the workpiece to the distal surface of the workpiece, and is not limited to the vertical height of the workpiece.

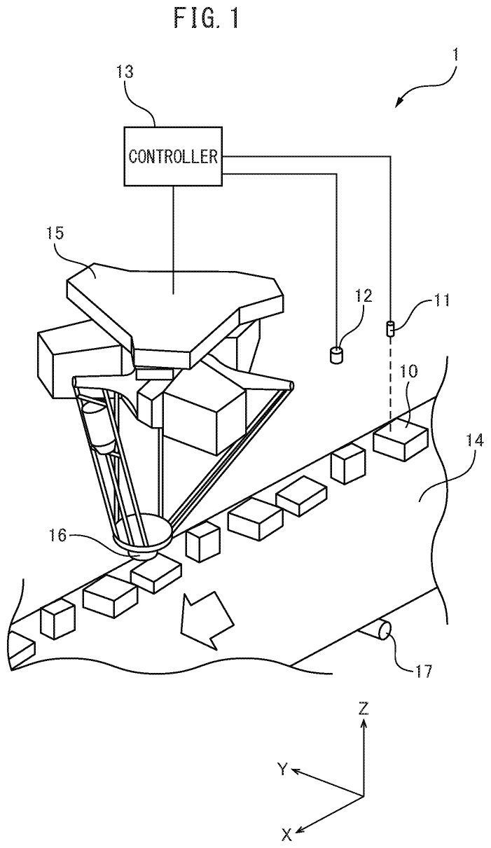

FIG. 1 shows the schematic configuration of a detection system 1 according to the present embodiment. The detection system 1 includes a height measurement sensor 11, a two-dimensional sensor 12, and a controller 13 which controls these two sensors. The workpiece 10 is an article such as a cardboard box, but may be a tray on which the article can be placed. A plurality of workpieces 10 having different heights are conveyed in one row or a plurality of rows by a transport section 14. The transport section 14 may be a conveyor or AGV (automated guided vehicle) or the like which is provided with a support surface which supports the workpiece 10. In the case of a conveyor, the transport section 14 may be an arcuate circulating conveyor.

The height measurement sensor 11 is a laser-type or ultrasonic distance sensor, but may be a photoelectric sensor or the like having a light emitting section and a light receiving section. In the case of a distance sensor, it is arranged so that the measurement direction thereof is perpendicular to the support surface of the workpiece 10, and the height of the workpiece 10 is measured by subtracting the distance to the distal surface of the workpiece 10 (in this example, the upper surface of the workpiece 10) from the distance to the support surface of the workpiece 10 measured in advance. In the case of a photoelectric sensor, it is arranged so that the light emitting direction thereof is orthogonal to the conveying direction X of the workpiece 10, and a plurality of photoelectric sensors are juxtaposed in the height direction of the workpiece 10, whereby the height of the workpiece 10 is measured from the position of the photoelectric sensor for which the light emitted therefrom is blocked by the workpiece 10. Further, when workpieces 10 are conveyed in a plurality of rows, height measurement sensors 11 may be provided in accordance with the number of rows.

The two-dimensional sensor 12 may be a two-dimensional camera which outputs two-dimensional information of the workpiece 10 (e.g., an image), and may be arranged so that the optical axis thereof is in the height direction of the workpiece 10. The two-dimensional sensor 12 is disposed on the downstream side of the height measurement sensor 11 in the conveying direction X of the workpiece 10, but may be disposed on the upstream side of the height measurement sensor 11.

The controller 13 may be a known controller including a processor such as a CPU (central processing unit), and manages the execution timing of at least one of the height measurement sensor 11 and the two-dimensional sensor 12, and detects at least the position of the workpiece 10 (and the posture of the workpiece as necessary) based on the measured height and the acquired two-dimensional information.

The detection system 1 may further include a movement amount detection section 17 that detects the movement amount of the workpiece 10. The movement amount detection section 17 may be a rotary encoder or the like mounted on the rotary shaft of the transport section 14. Alternatively, the controller 13 may detect the movement amount of the workpiece 10 from the information of the two-dimensional sensor 12. The controller 13 controls the tool 16 based on the detected movement amount of the workpiece 10 and the detected position of the workpiece 10 while causing the machine 15 to follow the moving workpiece 10. As a result, the machine 15 performs the operation while following the workpiece 10.

The machine 15 is a parallel link robot, but may be another industrial robot such as an articulated robot or may be another industrial machine such as a machine tool or construction machine. The tool 16 is a suction-type hand, but may also be a hand with a plurality of claws, and is used to transfer the workpiece 10 from the transport section 14 to another location or from another location to the transport section 14. Depending on the operation on the workpiece 10, the tool 16 may be another tool such as a sealing tool, a welding tool, a screw fastening tool, a soldering tool, a laser machining tool, or the like.

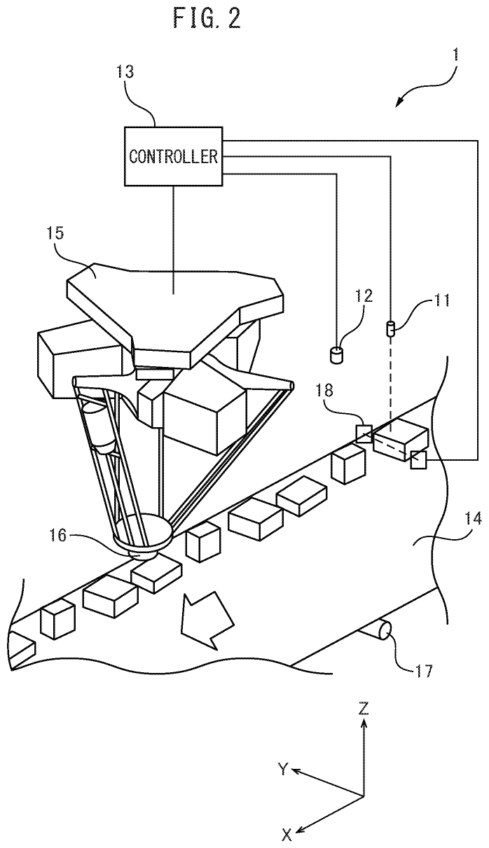

FIG. 2 shows a modified example of the configuration of the detection system 1. The detection system 1 may further include an arrival detection sensor 18 which detects the arrival of the workpiece 10. The arrival detection sensor 18 may be a photoelectric sensor including a light emitting section and a light receiving section, a contact sensor including a contact probe, or the like. In the case of a photoelectric sensor, it is arranged so that the light emitting direction thereof is orthogonal to the conveying direction X of the workpiece 10, and in the case of a contact sensor, it is arranged so that the contact probe thereof contacts the workpiece 10. The arrival detection sensor 18 may be disposed at substantially the same position as the height measurement sensor 11 or the two-dimensional sensor 12 disposed on the upstream side in the conveying direction X of the workpiece 10. In the configuration of FIG. 1, the controller 13 manages the execution timing of the height measurement sensor 11 or the two-dimensional sensor 12 based on the information of the height measurement sensor 11 or the two-dimensional sensor 12, whereas in the configuration of FIG. 2, the controller 13 manages the execution timing of the height measurement sensor 11 and the two-dimensional sensor 12 based on the information of the arrival detection sensor 18.

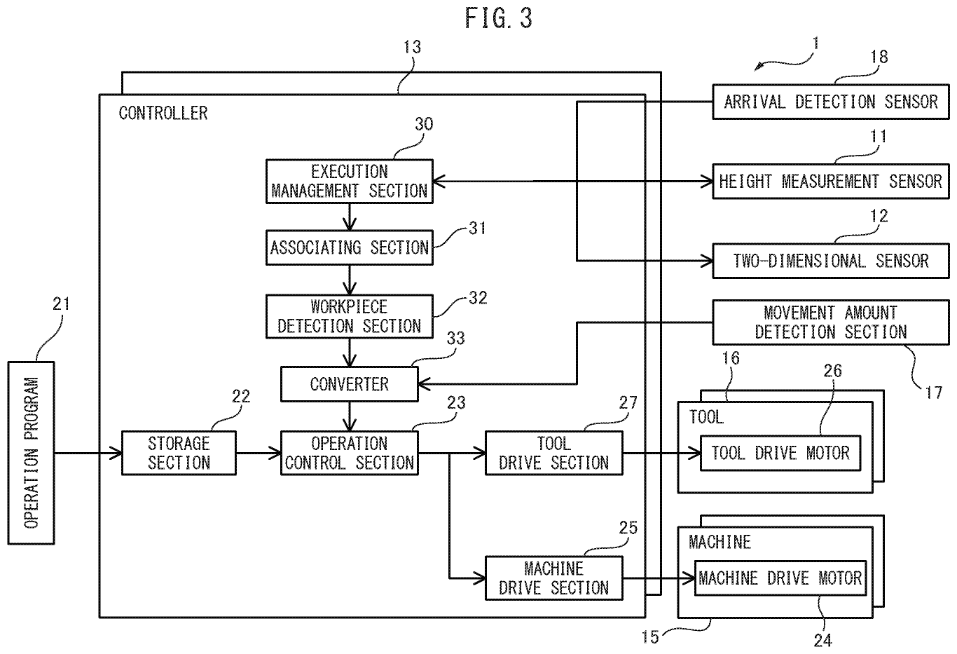

FIG. 3 shows functional blocks of the detection system according to the embodiment. The controller 13 includes an execution management section 30 which manages the execution timing of at least one of the height measurement sensor 11 and the two-dimensional sensor 12. The execution management section 30 manages the execution timing of the sensor, for example, as described below, in accordance with the configuration of the detection system shown in FIGS. 1 and 2.

(Configuration Using Only Height Measurement Sensor and Two-Dimensional Sensor)

(1) When arranging the height measurement sensor 11 on the upstream side of the two-dimensional sensor 12 in the conveying direction of the workpiece, the execution management section 30 executes the height measurement sensor 11 each time a predetermined time elapses, or each time the workpiece advances by a predetermined distance, or continuously, and executes the two-dimensional sensor 12 when a predetermined time has elapsed from the timing at which the predetermined height was detected by the height measurement sensor 11 or the workpiece moves by a predetermined distance. The predetermined time or the predetermined distance is appropriately defined in accordance with the workpiece speed, the distance between the sensors, and the like, but may be 0 hours or 0 distance as long as the height measurement sensor 11 is within the field of view of the two-dimensional sensor 12.

(2) When arranging the height measurement sensor 11 on the downstream side of the two-dimensional sensor 12 in the conveying direction of the workpiece, the execution management section 30 executes the two-dimensional sensor 12 each time a predetermined time elapses, or each time the workpiece advances a predetermined distance, or continuously, and executes the height measurement sensor 11 when a predetermined time has elapsed from the timing at which the workpiece was detected by the two-dimensional sensor 12 or when the workpiece moves by a predetermined distance. As described above, the predetermined time or the predetermined distance is appropriately defined in accordance with the workpiece speed, the distance between the sensors, and the like, but the predetermined time or the predetermined distance may be 0 hours or 0 distance as long as the height measurement sensor 11 is within the field of view of the two-dimensional sensor 12.

(Configuration Using an Arrival Detection Sensor in Addition to the Height Measurement Sensor and the Two-Dimensional Sensor)

(3) When arranging the height measurement sensor 11 on the upstream side of the two-dimensional sensor 12 in the conveying direction of the workpiece, the execution management section 30 executes the height measurement sensor 11 at the timing at which the arrival of the workpiece is detected by the arrival detection sensor 18, and executes the two-dimensional sensor 12 when a predetermined time elapses from the timing at which the arrival of the workpiece was detected or when the workpiece moves by a predetermined distance. As described above, the predetermined time or the predetermined distance is appropriately defined in accordance with the workpiece speed, the distance between the sensors, and the like, but the predetermined time or the predetermined distance may be 0 hours or 0 distance as long as the height measurement sensor 11 is within the field of view of the two-dimensional sensor 12.

(4) When arranging the height measurement sensor 11 on the downstream side of the two-dimensional sensor 12 in the conveying direction of the workpiece, the execution management section 30 executes the two-dimensional sensor 12 at a timing at which the arrival of the workpiece is detected by the arrival detection sensor 18, and executes the height measurement sensor 11 when a predetermined time elapses from the timing at which the arrival of the workpiece is detected or the workpiece moves by a predetermined distance. As described above, the predetermined time or the predetermined distance is appropriately defined in accordance with the workpiece speed, the distance between the sensors, and the like, but the predetermined time or the predetermined distance may be 0 hours or 0 distance as long as the height measurement sensor 11 is within the field of view of the two-dimensional sensor 12.

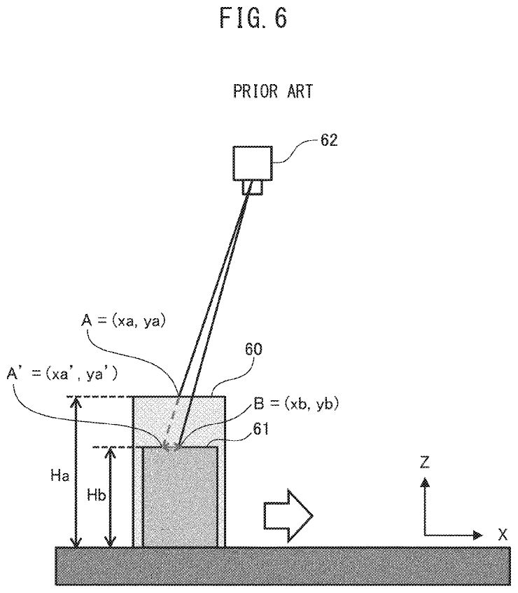

The controller 13 further includes a workpiece detection section 32 which detects at least the position of the workpiece (and the posture of the workpiece as necessary) based on the obtained two-dimensional information and the measured height. For example, in the case of the workpiece 60 shown in FIG. 6, the detection plane is set to the measured height Ha, and at least the three-dimensional position A of the workpiece 60 (xa, ya) is detected from the set detection plane and the obtained position of the workpiece 60 on the two-dimensional image (e.g., the center of gravity position of the upper surface of the workpiece on the two-dimensional image (u, v)). Known image processing techniques such as blob detection, pattern matching, and the like, can be used to detect the position (u, v) of the workpiece on the two-dimensional image. Further, when arranging the height measurement sensor 11 on the upstream side of the two-dimensional sensor 12 in the conveying direction of the workpiece, since the height of the workpiece is acquired before acquiring the two-dimensional information of the workpiece, the workpiece detection section 32 may detect the position of the workpiece while the workpiece moves in the field of view of the two-dimensional sensor 12.

Since the execution timings of the height measurement sensor 11 and the two-dimensional sensor 12 differ due to the workpiece speed or the workpiece amount, the controller 13 may further include an associating section 31 that associates the measured height with the acquired two-dimensional information for each workpiece. The associating section 31 stores and associates the measured height and the acquired two-dimensional information in a two-dimensional array, a database, or the like.

In order to control the machine 15 and the tool 16, the controller 13 may further comprise a converter 33 which converts at least the current position of the workpiece (and the movement amount of the workpiece if necessary) from the sensor coordinate system to the machine coordinate system. The current position of the workpiece can be estimated from the detected position of the workpiece and the movement amount of the workpiece detected at that time. The movement amount of the workpiece may be detected by the movement amount detection section 17, or may be detected from the two-dimensional information acquired by the two-dimensional sensor 12.

To control the machine 15 and the tool 16, the controller 13 may further include a storage section 22 which stores at least an operation program 21, an operation control section 23 which controls the operation of the machine 15 and the tool 16 based on the operation program 21, a machine drive section 25 which drives a machine drive motor 24, and a tool drive section 27 which drives a tool drive motor 26. The operation program 21 is a program in which basic operation commands of the machine 15 are described according to the contents of the operation, and the operation control section 23 sends the operation commands to the machine drive section 25 or the tool drive section 27 based on the operation program 21. The machine drive section 25 or tool drive section 27 supplies power to the machine drive motor 24 or tool drive motor 26 based on the operation commands.

When the workpiece enters the operational area of the machine 15, the converter 33 converts at least the current position of the workpiece (and the movement amount of the workpiece if necessary) from the sensor coordinate system to the machine coordinate system and continuously transmits it to the operation control section 23. The operation control section 23 continuously transmits operation commands to command that the current position of the workpiece is the target position of the machine to the machine drive section 25 and controls the tool drive section 27. As a result, the machine 15 can perform the operation while pursuing the workpiece. When the operation on the specific workpiece is completed, the converter 33 continuously converts the current position of a subsequent workpiece into the machine coordinate system and transmits the converted position to the operation control section 23, and the above-described operation is repeated.

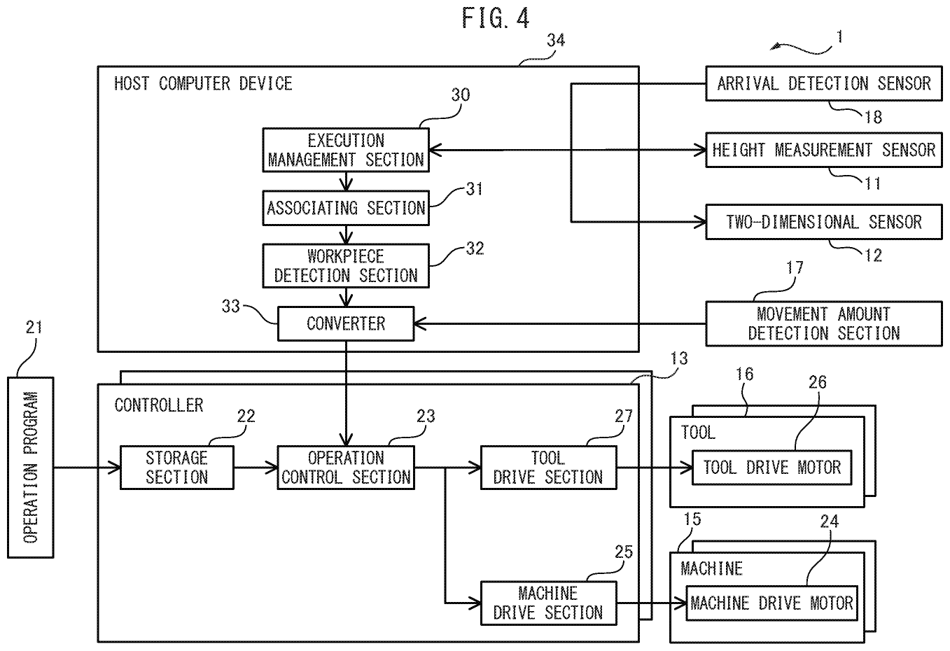

FIG. 4 shows a configuration of the detection system 1 according to another embodiment. In this configuration, the detection system 1 includes a host computer device 34 including a processor such as a CPU, and the host computer device 34 is communicably connected to each controller 13. The host computer device 34 is configured so as to process the information acquired from the various sensors such as the height measurement sensor 11, the two-dimensional sensor 12, the arrival detection sensor 18, and the movement amount detection section 17 at high speed, transmit various commands to each controller 13 based on the processing results. The execution management section 30, the associating section 31, the workpiece detection section 32, and the converter 33 are not individually provided in the controller 13, but are aggregated in the host computer device 34. As a result, various programs, various data, and the like can be shared among a plurality of controllers 13, whereby the maintainability of the detection system 1 can be improved.

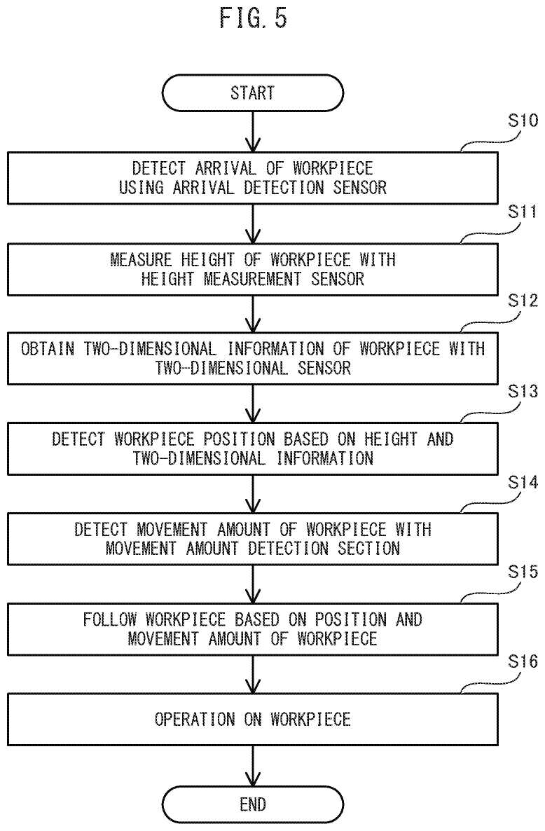

FIG. 5 shows the schematic operations of the detection system 1. In step S10, the arrival of the workpiece is detected using the arrival detection sensor. In step S11, the height measurement sensor is executed at the timing at which the arrival of the workpiece is detected, and the height of the workpiece is measured. However, when the arrival detection sensor is not used, step S10 becomes unnecessary, and the height measurement sensor may be executed every time a predetermined time elapses, every time the workpiece advances by a predetermined distance, or continuously.

In step S12, the two-dimensional sensor is executed when after a predetermined time has elapsed from the timing at which the arrival of the workpiece is detected or the workpiece moves by a predetermined distance or the workpiece moves by a predetermined distance, and the two-dimensional information of the workpiece is acquired. However, in the case of not using the arrival detection sensor, the two-dimensional sensor may be executed when a predetermined time has elapsed from the timing at which the predetermined height is detected by the height measurement sensor or the workpiece moves by a predetermined distance. Further, when arranging the height measurement sensor on the downstream side of the two-dimensional sensor in the conveying direction of the workpiece, the order of the step S11 and step S12 may be switched, and the height measurement sensor may be executed when a predetermined time has elapsed from the timing at which the workpiece is detected by the two-dimensional sensor or the workpiece moves by a predetermined distance.

In step S13, the position of the workpiece (and the posture of the workpiece if necessary) is detected from the obtained two-dimensional information and the measured height. Note that since the execution timings of the height measurement sensor and the two-dimensional sensor differ due to the workpiece speed and the workpiece amount, between the step S12 and the step S13, the measured height and the acquired two-dimensional information may be associated with each other for each workpiece. In step S14, the movement amount of the workpiece is detected by the movement amount detection section. However, the movement amount of the workpiece may be detected from the information of the two-dimensional sensor. In step S15, the machine follows the workpiece based on the position of the workpiece and the movement amount of the workpiece, and in step S16, the operation is performed on the workpiece.

According to the above embodiments, since the execution timings of the height measurement sensor and the two-dimensional sensor are managed, it is possible to suppress missed workpieces by the sensor. Further, since the position of the workpiece is detected in consideration of the height of the workpiece, it becomes possible to accurately detect the position of the workpiece. Thus, a reliable detection system can be provided without the use of expensive three-dimensional sensors.

The “sections” described above may be constituted by semiconductor integrated circuits, or may be constituted by programs which are executed by a processor. Furthermore, the program which executes the flowchart described above may be stored and provided on a computer-readable non-transitory storage medium, for example, a CD-ROM.

Though various embodiments have been described in the present description, the present invention is not limited to the embodiments described above, and various modifications can be made within the scope described in the claims below.

1. A detection system, comprising:
a height measurement sensor which measures height of a moving workpiece,
a two-dimensional sensor which acquires two-dimensional information of the workpiece,
an execution management section which manages execution timing of at least one of the height measurement sensor and the two-dimensional sensor, and
a workpiece detection section which detects at least a position of the workpiece based on the measured height and the acquired two-dimensional information.

2. The detection system according to claim 1, wherein the execution management section manages the execution timing based on information of the height measurement sensor or the two-dimensional sensor.

3. The detection system according to claim 1, wherein the execution management section executes the two-dimensional sensor based on a timing at which a predetermined height is detected by the height measurement sensor, or executes the height measurement sensor based on a timing at which the workpiece is detected by the two-dimensional sensor.

4. The detection system according to claim 1, wherein the execution management section executes the height measurement sensor or the two-dimensional sensor when a predetermined time elapses, when the workpiece moves by a predetermined distance, or continuously.

5. The detection system according to claim 1, wherein the workpiece detection section detects a position of the workpiece while the workpiece moves within a field of view of the two-dimensional sensor.

6. The detection system according to claim 1, further comprising an arrival detection sensor which detects arrival of the workpiece, wherein the execution management section executes the height measurement sensor and the two-dimensional sensor based on information of the arrival detection sensor.

7. The detection system according to claim 1, further comprising an associating section which associates the measured height with the acquired two-dimensional information for each workpiece.

8. The detection system according to claim 1, wherein the workpiece detection section sets a detection plane to the measured height, and detects the position of the workpiece based on the set detection plane and the acquired two-dimensional information.

9. The detection system according to claim 1, further comprising:
a movement amount detection section which detects movement amount of the workpiece, and
a machine which performs an operation while following the workpiece based on the detected position of the workpiece and the detected movement amount.

10. The detection system according to claim 1, wherein the workpiece comprises an article or a tray on which the article can be placed.

11. The detection system according to claim 9, wherein the machine comprises a robot or industrial machine.
